(19) United States
(12) Patent Application Publication
(10) Pub. No.: US 2020/0238282 A1
(43) Pub. Date: Jul. 30, 2020

(54) FLUID HANDLING APPARATUS FOR A BIOPROCESSING SYSTEM

(71) Applicant: GE HEALTHCARE BIO-SCIENCES CORP., Marlborough, MA (US)

(72) Inventors: Andrew Arthur Paul Burns, Niskayuna, NY (US); Dennis Cherok, North Smithfield, RI (US); Mark Timmins, Chelmsford, MA (US); Pei-Hsin Kuo, Niskayuna, NY (US); Weston Blaine Griffin, Niskayuna, NY (US)

(73) Assignee: GE HEALTHCARE BIO-SCIENCES CORP., Marlborough, MA (US)

(21) Appl. No.: 16/256,444

(22) Filed: Jan. 24, 2019

(51) Int. Cl. B01L 3/00

(52) U.S. Cl. CPC B01L 3/502715; B01L 2300/049; B01L 2300/123

(57) ABSTRACT

A fluid handling apparatus for a bioprocessing system includes a first plate having a first surface and a second surface, at least one fluid flow channel formed in the first surface, at least one valve recess formed in the first surface along the at least one fluid flow channel, and at least one fluid passageway extending through the first plate from the at least one fluid flow channel to the second surface, and a sealing layer disposed over the first surface and enclosing the at least one fluid flow channel. The at least one valve recess is configured to cooperate with an actuator and the sealing layer to prevent a flow of fluid through the at least one fluid flow channel.

### BACKGROUND

### Technical Field

Embodiments of the invention relate generally to bioprocessing systems and methods and, more particularly, to a fluid handing apparatus for a bioprocessing system.

### DISCUSSION OF ART

A variety of vessels, devices, components and unit operations are known for carrying out biochemical and/or biological processes and/or manipulating liquids and other products of such processes. Such biological processes may be used in, for example, the manufacture of cellular immunotherapies such as chimeric antigen receptor (CAR) T cell therapy, which redirects a patient's T cells to specifically target and destroy tumor cells. As is known in the art, the manufacture of cellular immunotherapies, such as CAR T cell therapy, may involve the extraction, activation, genetic modification, culture and expansion of cells in one or more bioreactor vessels.

Recent advancements in the manufacture of cellular immunotherapies have provided for the automation of many bioprocess steps. For example, activation, genetic modification and/or expansion of a population of cells may be carried out in an automated or quasi-automated manner without substantial human operator intervention. U.S. Provisional Application Ser. No. 62/736,144, which is hereby incorporated by reference herein in its entirety, discloses one example of a functionally-closed, automated system for the manufacture of a CAR T cell therapy. As disclosed therein, fluid handling, including the addition and removal of various cell cultures, inoculum, media, reagents, rinse buffers, etc. into and from the bioreactor vessel(s) at precise volumes, rates, times and durations is an important aspect in the automation of cell therapy production. As disclosed in the '144 application, many individual fluid transfer operations (e.g., filling and emptying bioreactor vessels, feed cells, addition of reagents, etc.) are routed through a fluidic network controlled by an array of valves and driven by multiple pumps. The fluidic network is formed from a number of PVC and silicone tubes joined together connectors. The tubes are retained in place on a manifold where they can be compressed against an anvil by an array of solenoid actuators to selectively prevent or allow a flow of fluid through the tubes. Together, the solenoid array and the anvil form a pinch valve array. The tubes are also retained in place so that one or more pump heads may engage the tubes to move fluid through the tubes to or from the bioreactor vessel(s) and/or the various fluid or collection reservoirs.

While the fluidic network disclosed in the '144 patent facilitates the automation of a number of bioprocess steps, assembly of such fluidic network can be quite costly and complex, requiring a significant amount of manual labor. In particular, assembling the fluidic network may involve the fitting together of over 100 parts and leak testing each flow pathway prior to use.

In view of the above, there is a need for a fluid handling apparatus for a bioprocessing system that is easier and less costly to assemble, minimizes the potential for human assembly errors, and simplifies inspection and leak testing.

### BRIEF DESCRIPTION

In an embodiment, a fluid handling apparatus for a bioprocessing system includes a first plate having a first surface and a second surface and a sealing layer disposed over the first surface. At least one fluid flow channel is formed in one of the first surface of the first plate or the sealing layer. At least one valve recess is formed in one of the first surface of the first plate or the sealing layer. The at least one valve recess is configured to cooperate with an actuator to prevent a flow of fluid through the at least one fluid flow channel.

In another embodiment, a fluid control system includes an array of actuators and a fluidic manifold. The fluidic manifold includes a first plate having a first surface and a second surface, a plurality of fluidic channels formed in the first surface, a plurality of valve recesses formed in the first surface along one or more of the fluidic channels, and at least one fluid passageway extending through the first plate from at least one of the fluidic channels to the second surface, and a sealing layer disposed over the first surface and enclosing the plurality of fluidic channels. Each of the actuators is moveable into engagement with the sealing layer of the fluidic manifold to urge the sealing layer into contact with a surface of a corresponding valve recess to occlude fluid flow in at least one of the fluidic channels.

In yet another embodiment, a method of fluid control for a bioprocessing system includes the steps of arranging a fluidic manifold adjacent to an array of actuators, the fluidic manifold including a first plate having a first surface and a second surface, at least one fluid flow channel formed in the first surface, at least one valve recesses formed in the first surface along a fluidic channel of the at least one fluidic channel, and a sealing layer disposed over the first surface and enclosing the at least one fluid flow channel, and actuating at least one of the actuators to urge the sealing layer into contact with a valve recess to occlude fluid flow past the valve recess.

In yet another embodiment, a fluid handling apparatus for a bioprocessing system includes a first plate having a first surface and a second surface, a sealing layer in registration with the first surface, at least one fluid flow channel formed in at least one of the first surface and the sealing layer, at least one valve recess formed in at least one of the first surface and the sealing layer along the at least one fluid flow channel, and at least one fluid passageway extending through the first plate from the at least one fluid flow channel to the second surface. The at least one valve recess is configured to cooperate with an actuator and the sealing layer to prevent a flow of fluid through the at least one fluid flow channel.

In yet another embodiment, a bioprocessing system includes a bioreactor vessel, a bioprocessing device, and a fluid handling apparatus configured for fluid connection to the bioreactor vessel and the bioprocessing device, the fluid handling apparatus including a first plate and a sealing layer, at least one fluid flow channel in the first plate or the sealing layer, and at least one valve recess in the first plate or the sealing layer. The at least one valve recess is configured to cooperate with an actuator to prevent a flow of fluid through the at least one fluid flow channel.

### DRAWINGS

The present invention will be better understood from reading the following description of non-limiting embodiments, with reference to the attached drawings, wherein below.

FIG. 1 is an exploded, perspective view of a fluid handing apparatus for a bioprocessing system, according to an embodiment of the invention.

FIG. 2 is a perspective view of a first plate of the fluid handling apparatus of FIG. 1, illustrating the fluidic channels thereof.

FIG. 3 is a perspective view of a second plate of the fluid handling apparatus of FIG. 1.

FIG. 4 is an enlarged, plan view of a valve recess of the fluid handling apparatus of FIG. 1, according to an embodiment of the invention.

FIG. 5 is a cross-sectional illustration of the valve recess of FIG. 4, showing a perpendicular-to-flow cross-section.

FIG. 6 is a cross-sectional illustration of the valve recess of FIG. 4, showing a flow-direction cross-section.

FIG. 7 is a cross-sectional illustration of a valve recess according to another embodiment of the invention, showing a perpendicular-to-flow cross-section.

FIG. 8 is a cross-sectional illustration of the valve recess of FIG. 7, showing a flow-direction cross-section.

FIG. 9 is a front, perspective view of a fluid control system according to an embodiment of the invention, showing installation of the fluid handling apparatus of FIG. 1.

FIG. 10 is another front, perspective view of a fluid control system of FIG. 9, showing an installed position of the fluid handling apparatus.

FIG. 11 is a top plan view of the fluid control system of FIG. 9.

FIG. 12 is a rear, perspective view of the fluid control system of FIG. 9.

FIG. 13 is a cross-sectional illustration of the fluid handling apparatus of FIG. 1, illustrating a fluid flow channel.

FIG. 14 is another cross-sectional illustration of the fluid handling apparatus of FIG. 1, illustrating a valve actuation.

FIG. 15 is a top plan view of a fluid handing apparatus, according to another embodiment of the invention.

FIG. 16 is an enlarged, plan view of a portion of the first plate of the fluid handling apparatus of FIG. 15, illustrating the positioning of attachment points.

FIG. 17 is a schematic illustration of the fluid handling apparatus of FIG. 1, incorporating a pressure sensing/transduction system according to an embodiment of the invention.

FIG. 18 is a schematic illustration of a bioprocessing system incorporating the fluid handling apparatus of FIG. 1, according to an embodiment of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

As used herein, “fluidly coupled” or “fluid communication” means that the components of the system are capable of receiving or transferring fluid between the components. The term fluid includes gases, liquids, or combinations thereof. As used herein, “operatively coupled” refers to a connection, which may be direct or indirect. The connection is not necessarily a mechanical attachment.

While embodiments of the invention are described herein in connection with the manufacture of biotherapeutic applications such as the manufacture of cell therapies and monoclonal antibodies, the invention is not so limited in this regard. In particular, it is contemplated that the fluidic assembly/fluid handing apparatus of the invention may be utilized in any field where fluid flow management is needed or desired. Moreover, the fluid handing apparatus of the invention may be used for both liquid and gaseous fluid management.

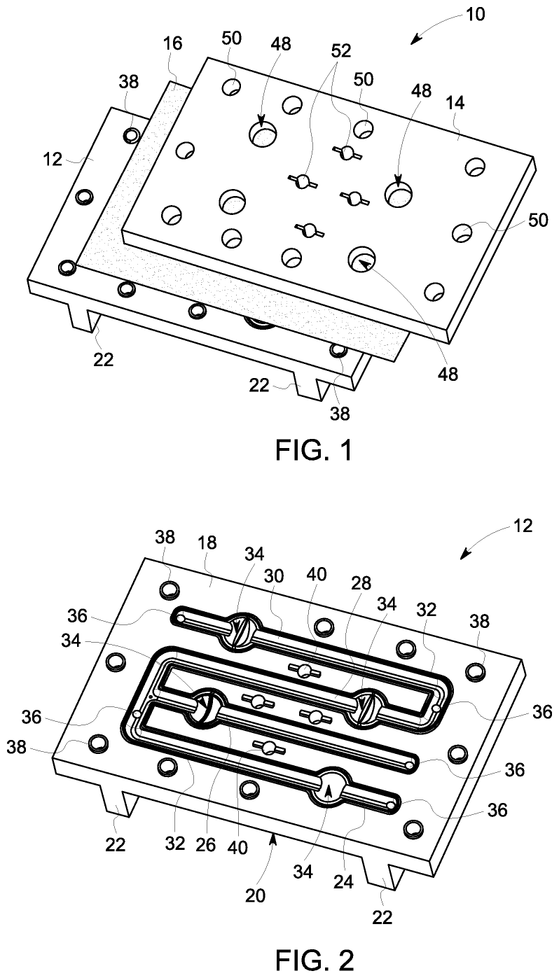

With reference to FIG. 1, a fluid handling apparatus 10, also referred to herein as a fluidic manifold, according to an embodiment of the invention, is illustrated. The fluid handling apparatus 10 includes a first plate 12, a second plate 14 and a membrane or sealing layer 16 sandwiched intermediate to the first plate 12 and the second plate 14. In an embodiment, the first plate 12 and the second plate 14 are substantially rigid and formed from polycarbonate or another sufficiently rigid and tough material, although other materials may be utilized without departing from the broader aspects of the invention. In another embodiment, the sealing layer 16 is a flexible layer composed of a flexible polymer material. In one embodiment, the sealing layer 16 is a cross-linked, hydrophobic material such as silicone. In an embodiment, the sealing layer 16 may have a thickness in the range of about 40 mils to about 60 mils, and have a hardness between about 40-50 Shore A. In an embodiment, the sealing layer 16 may have a thickness in the range of about 40 mils to about 60 mils, and have a hardness of about 50 Shore A. A sealing layer with these specifications has been discovered to avoid situations where the sealing layer can distend out of the array during high pressure/rate input pumping and potentially burst or distend inwards during high pressure/rate output pumping, and/or potentially occlude flow by suctioning against the valve bowl (as has beenobserved in thinner/lower durometer materials (e.g., 0.020 inch thickness, 20 Shore A durometer)).

In a further embodiment, rather than being rigid, the first plate 12 and/or second plate may be compliant or flexible so as to compensate for variations in components that will permit positive sealing between the first plate 12 and sealing layer 16.

As best shown in FIG. 2, the first plate 12 includes a first surface 18, an opposed second surface 20, and a pair of ribs 22 that protrude from the second surface 20. In an embodiment, the ribs 22 may be omitted and/or the second surface 20 may be substantially flat. One or more fluid flow channels or fluidic channels, e.g., fluid flow channels 24, 26, 28, 30, are formed in the first surface 18 (i.e., inward-facing surface) to allow for the passage of a fluid, as discussed hereinafter. As illustrated in FIG. 2, the flow channels 24, 26, 28, 30 are bounded by a peripheral ridge 32 that protrudes above the first surface 18 and extends along substantially an entire periphery of the fluid flow channels. In an embodiment, the ridge 32 may have a cross-section or profile that is a pointed, inverted “v” shape, triangular shape, or a semi-circular shape. As discussed below, the ridge 32 provides a surface against which the sealing layer 16 may be compressed to form a seal to maintain the fluid within the fluid flow channels. In an embodiment, the ridge 32 may have a height less than or equal to two thirds of the thickness of the sealing membrane/layer 16. For example, in an embodiment with a sealing layer that is 0.040 inches thick with a 50 Shore A durometer, a sealing ridge 32 with a height (semicircular radius) of 0.015 inches may be used successfully. At least one of the fluid flow channels 24, 26, 28, 30 includes a valve recess 34 that is configured to cooperate with an actuator for selectively preventing or allowing fluid to flow through the channel(s) past the valve recess. In an embodiment, each of the fluid flow channels 24, 26, 28, 30 includes an associated valve recess 34.

As also shown in FIG. 2. the first plate 12 also includes one or more fluid passageways 34 that extend though the first plate 12 from at least one of the fluid flow channels 24, 26, 28, 30 to the second surface 20, forming a port at the second surface 20. In some embodiments, one or more of the fluid passageways 36 may extend through the ribs 22 and form a port in the ribs 22. The ports formed by the fluid passageways 36 allow for the connection of tubing to the fluid handling apparatus 10, as discussed hereinafter. In an embodiment, the fluid passageways 36 may be input and/or output passageways, allowing for fluid to be provided to the associated fluid flow channel(s), and/or removed from the associated fluid flow channel(s). In an embodiment, the flow channels have a cross-section that is selected to substantially match the internal cross-sectional area of the inlet tubing to prevent or minimize constriction of flow.

The first plate 12 additionally includes a plurality of alignment features, e.g., protrusions 38 that extend above the first surface 18 and facilitate alignment of the first plate 12 with the second plate 14. In an embodiment, the protrusions 38 may be hollow protrusions having a passage that extends entirely through the first plate 12, which allow for a fastener to be inserted therethrough. As shown in FIG. 2, a plurality of apertures 40 are formed through the first plate 12 which are, likewise, configured to receive fasteners for joining the first plate 12 to the second plate 14, in the manner described hereinafter. In an embodiment, the protrusions 38 may be configured as position stops of predetermined height that are used to define (i.e., set) the thickness of the gap between the first plate 12 and the second plate 14 around the sealing layer 16 to ensure that substantially even compression is generated throughout. In an embodiment, the height of these protrusions may be defined to be approximately the height of the sealing membrane. In another embodiment, the height of these protrusions may be less than the thickness of the sealing membrane, for example approximately half the height of the sealing membrane. As an example, for an embodiment comprising a 0.040 inch thick sealing membrane with a Shore A durometer of 50, protrusions of 0.0385 inches may be used. In an alternate embodiment using the same thickness and durometer membrane, protrusions of 0.020 inch thickness may be employed. In yet another embodiment, the protrusions 38 may not protrude above surface 18.

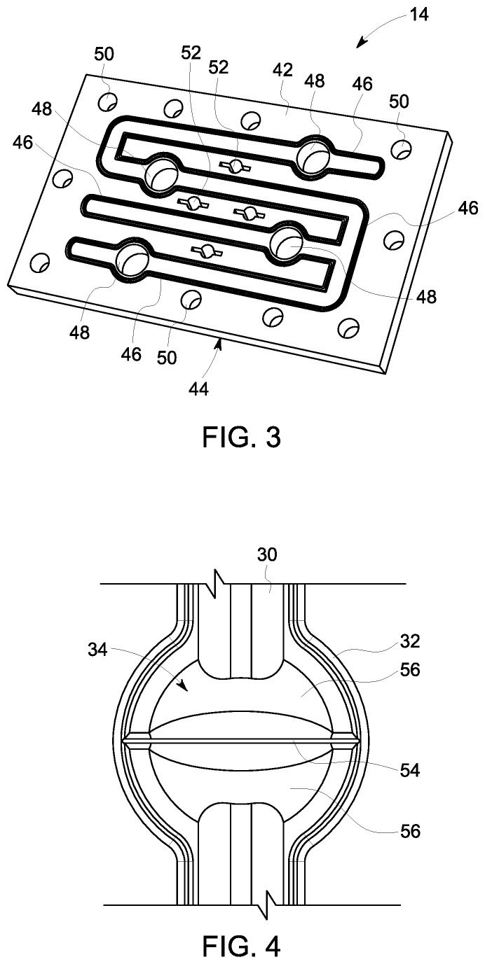

Turning now to FIG. 3, the configuration of the second plate 14 is illustrated. As shown therein, the second plate 14 includes an inward-facing first surface 42 and an opposed second surface 44. The first surface 42 of the second plate 14 includes a plurality of grooves 46 that substantially mirror the ridge(s) in the first plate 12. The groove(s) 46 are configured to receive the ridge(s) 32 of the first plate 12 when the inward facing surfaces 18, 42 of the first plate 12 and the second plate 14 are placed in faced-relationship to one another. In an embodiment, the first plate 12 and the second plate 14 may each have corresponding positive and/or negative relief features (e.g., a series of negative relief features in the second plate that are configured to mate with positive (i.e., protruding) features in the first plate, and a series of positive (i.e., protruding) features in the second plate that are configured to mate with negative relief features in the first plate). The mirrored positive and negative relief features in the first and second plates 12, 14 form a seal geometry (with the sealing layer 16 sandwiched in between) to maintain fluid within the fluid flow channels and prevent leaks. In an embodiment, the sealing layer 16, itself, may include features that form a part of the seal at the edge of the fluid flow channels. For example, in an embodiment, the sealing layer 16 may be formed with one or more raised or O-ring-like features which may be aligned with negative relief features in one or both of the adjoining plates 12, 14 to form a fluid-tight seal. While FIG. 3 illustrates the second plate 14 having grooves 46 that mirror the ridges in the first plate, it is contemplated that the grooves may be omitted, in which case the inward-facing surface of the second plate 14 is substantially flat (i.e., devoid of any corresponding grooves).

As further shown in FIG. 3, the second plate 14 includes a plurality of valve apertures 48 that correspond in size, shape and/or location to the valve recesses 34 of the first plate 12, a plurality of alignment apertures 50 that are dimensioned and positioned to receive the alignment protrusions 38 of the first plate 12, and a plurality of apertures 52 that correspond with the apertures 40 of the first plate 12 and are configured to receive fasteners for joining the first plate 12 to the second plate 14. In this respect, the first surface 42 of the second plate 14 is essentially a mirror image of the first surface 18 of the first plate 12.

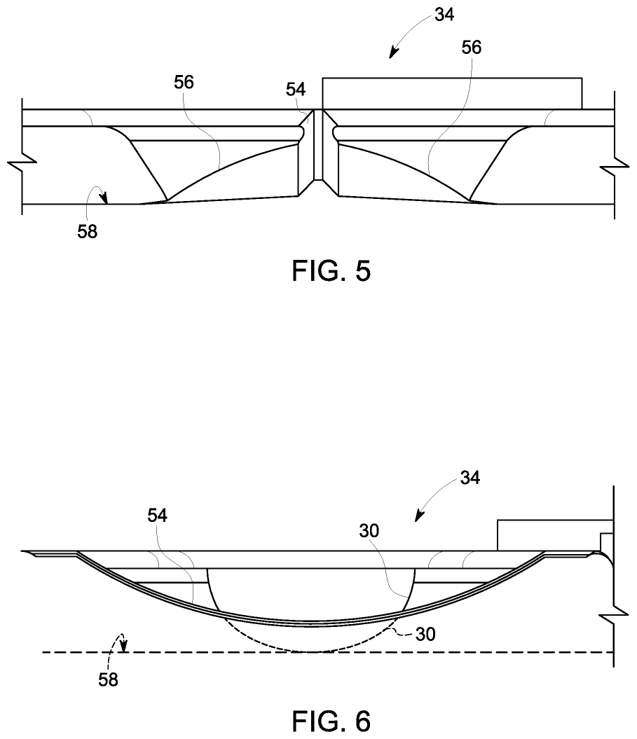

Referring to FIG. 4, the valve recesses 34 may have one of various configurations. For example, each of the valve recesses 34 may have no ridge (having a generally smooth and uninterrupted, hemispherical bottom surface), a contoured ridge extending across the valve recess (perpendicular to the flow direction), or a high ridge extending across the valve recess (perpendicular to the flow direction). It is contemplated that the valve recesses 34 may have a largest dimension that is greater than, or less than, the width of the associated fluid flow channel. FIGS. 4-6 illustrate one example of a high ridge valve configuration. As shown therein, the valve recess 34 includes a concave ridge 54 that extends across the valve recess 34 and protrudes upwardly from a bottom surface 56 thereof. In an embodiment, as best illustrated in FIG. 5, the bottom surface 56 of the valve recess 34 may be generally convex in shape, being deeper adjacent to the opposed portions of the flow channel 30 and shallower as the bottom surface approaches the ridge 54. In an embodiment, this convex shape may help to minimize or prevent the formation of eddies. As shown in FIG. 4-6, in an embodiment, the valve recess 34 has a bottom surface that, at its deepest, is substantially coextensive with a bottom surface 58 of the flow channel 30.

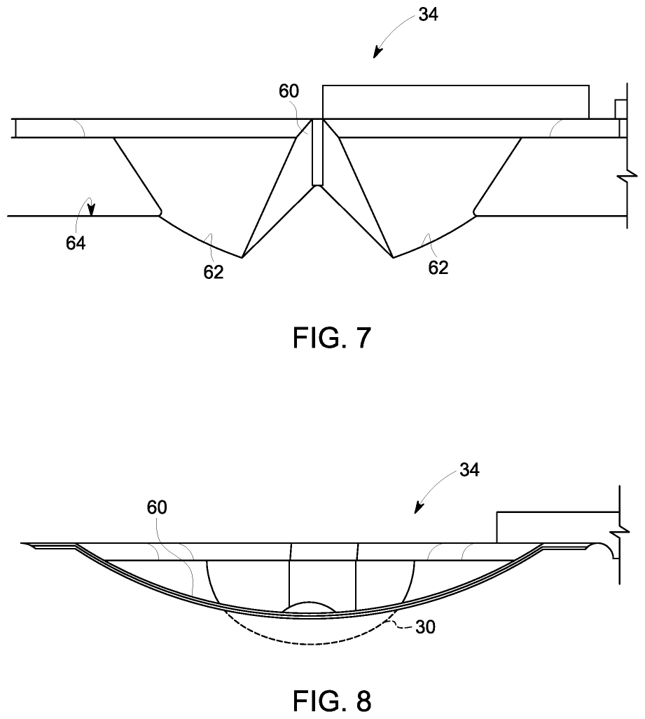

Referring to FIGS. 7 and 8, a valve recess 34 according to another embodiment of the invention is shown. The valve recess 34 of FIGS. 7 and 8 is generally similar in configuration to the valve recess of FIGS. 4-6, and includes a concave ridge 60 that extends across the valve recess 34 and protrudes upwardly from a bottom surface thereof. Rather than having a generally convex bottom surface, however, the valve recess 34 of FIGS. 7 and 8 includes troughs 62 on opposite sides of the ridge that are deeper than the bottom surface 64 of the associated flow channel. In any of the embodiments described herein, the geometry (i.e., profile or curvature) of the ridge of the valve recess corresponds with, or is compatible with, the geometry (i.e., profile or curvature) of the end of the corresponding actuator so that the actuator and ridge cooperate to occlude flow through the valve recess, as described hereinafter. For example, the radius of curvature of the valve ridge of the valve recess may be equal to the sum of the radius of curvature of the head of the actuator and the thickness of the sealing membrane/layer.

Referring back to FIGS. 1-3, in use, the sealing layer 16 is positioned intermediate the first plate 12 and the second plate 14, and the first plate 12 is aligned with the second plate using alignment protrusions 38 and corresponding recesses 50. Mechanical fastening members such as, for example, bolts, are then inserted through the aligned apertures 38, 50 and 40, 52 in the first plate 12 and second plate 14, respectively, and secured to nuts. The bolts are then tightened to compress the sealing layer 16 between the plates 12, 14. In particular, the bolts are tightened to compress the sealing layer 16 against the ridge(s) on the first plate 12 to sealingly enclose the fluid flow channels 24, 26, 28, 30. Other mechanical fastening means such as screws, or thermal welding (e.g., ultrasonic welding or heat staking) may also be utilized to secure the plates to one another and compress the sealing layer therebetween, without departing from the broader aspects of the invention. Fluid tubes may then be connected to the ports on the first plate 12 to provide fluid to, and remove fluid from, the fluid handling apparatus 10. In an embodiment, the tubes may be connected to the apparatus 10 using any connection means known in the art including, for example, welding or adhesives.

In an embodiment, the first and second plates 12, 14, and the various features thereof (flow channels, valve recess, ridges, alignment apertures, apertures for receiving fasteners) may be formed using additive manufacturing technologies such as 3D printing, although other manufacturing methods such as machining, molding and the like may also be utilized, without departing from the broader aspects of the invention.

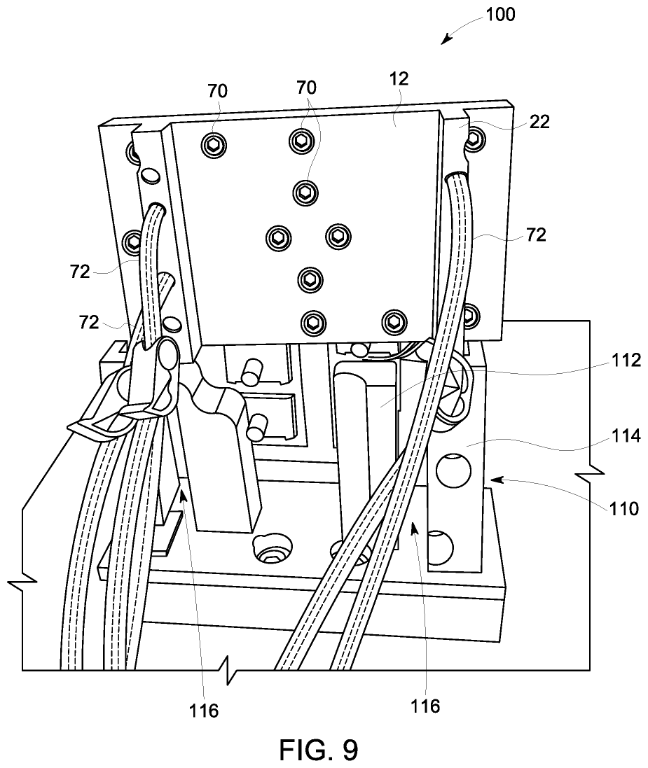

Turning now to FIGS. 9-12, a fluid control system 100 incorporating the fluid handling apparatus 10 of FIG. 1 is illustrated. As shown therein, the fluid handling apparatus 10 is assembled in the manner described above using fasteners 70 or similar means. A plurality of fluid tubes 72 can then be connected to the fluid passageways 36 to allow for fluid to be transferred into and out of the fluid flow channels. These fluid tubes may, in turn, be connected to various reservoirs containing fluids used in a bioprocessing or cell culturing process, such as cell cultures, inoculum, media, reagents, rinse buffers, etc., as well as collection and/or waste reservoirs, and/or one or more bioreactor vessels. Examples of various bioprocessing system architectures within which the fluid handling apparatus 10 may be integrated, including the various fluids, collection vessels and bioprocessing vessels that may be fluidly connected to the fluid handling apparatus 10 through connected tubes 72, are described in more detail in U.S. Provisional Application Ser. No. 62/736,144.

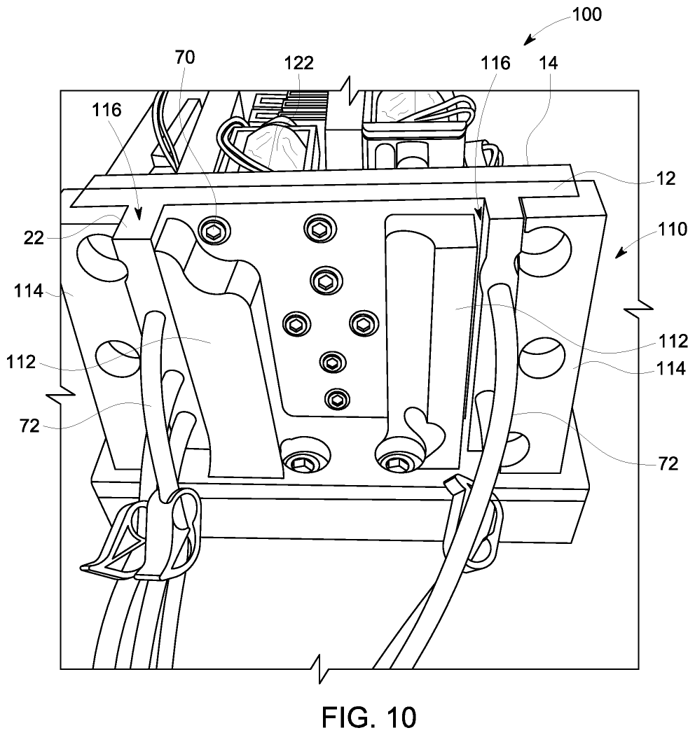

As shown in FIGS. 9-12, the fluid control system 100, in addition to the fluid handling apparatus 10, may include a positioning block 110 and actuator array 120 positioned proximate to one another. As best shown in FIGS. 9 and 10, the positioning block 110 has a pair of opposed members 112, 114 defining a channel 116 configured to slidably receive the ribs 22 of the first plate 12. In an embodiment, the positioning block 110 may have a chevron or tapered alignment feature for receiving the ribs 22. The ribs 22 of the fluid handling apparatus 10 are slidably received in the channels 116 in the positioning block 110 such that the fluid handling apparatus 10 is held in generally fixed position. In particular, the positioning block 110 substantially prevents movement of the fluid handling apparatus 10 in a direction perpendicular to first and second surfaces of the first plate and second plate.

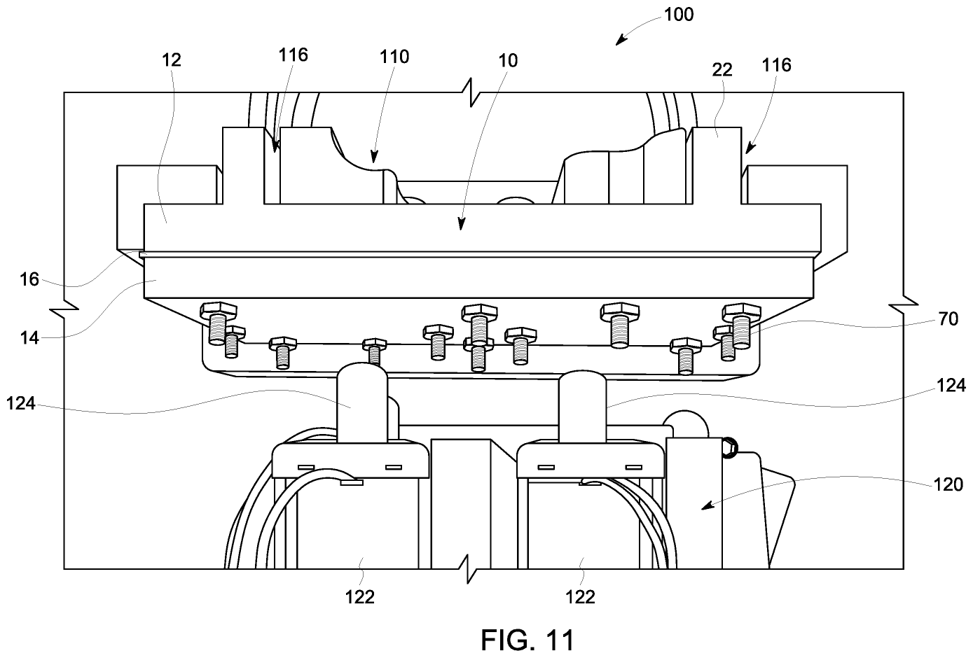

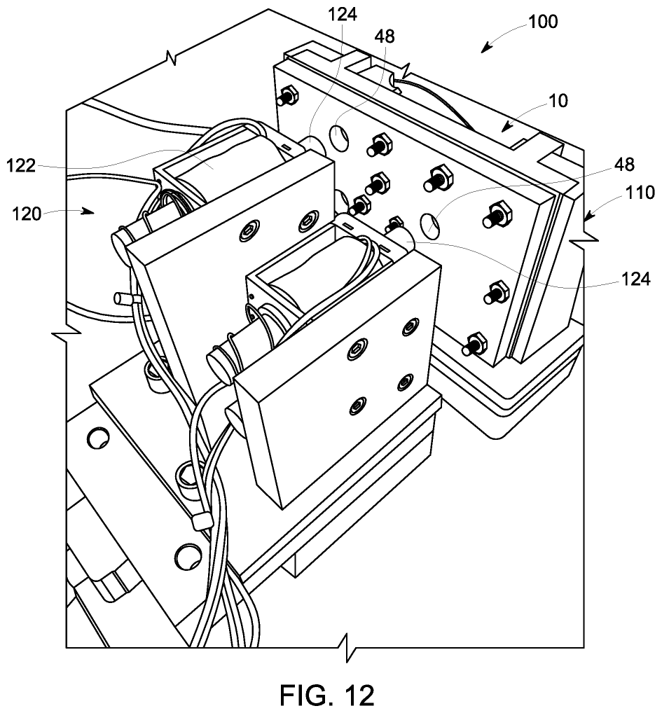

As best shown in FIGS. 11 and 12, the actuator array 120 includes a plurality of actuators, e.g., linear actuators 122, each having a plunger 124. In an embodiment, the linear actuators 122 are solenoids. Other actuator types and mechanisms such as, for example, mechanical springs, motor-driven captured lead-screw assemblies, pneumatic or hydraulically operated plungers and the like may also be utilized without departing from the broader aspects of the invention. The plungers 124 are positioned so as to be aligned with the valve apertures 48 in the second plate 14 and are extendable therethrough to compress the sealing layer 16 against the valve recesses 34 to occlude fluid flow through an associated fluid flow channel. In this respect, the fluidic manifold 10 and the linear actuator array 120 forms a pinch valve array that is selectively actuatable to allow or occlude flow through one or more of the fluid flow channels 24, 26, 28, 30 to support various bioprocessing operations (e.g., feeding, rinsing, perfusion, draining, etc.).

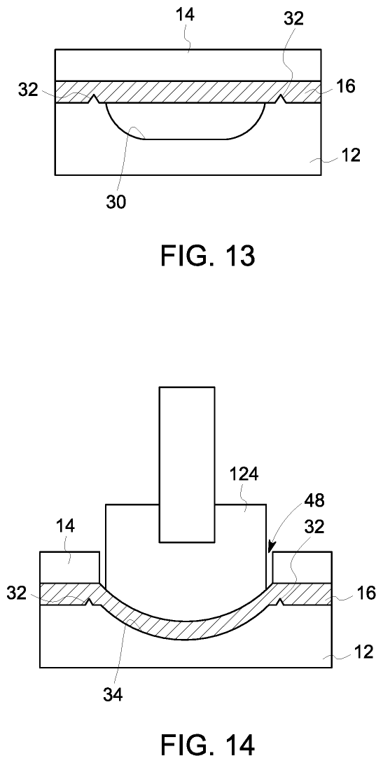

FIG. 13 is a cross-section of the fluid handling apparatus 10 illustrating compression of the sealing layer 16 against ridge 32 between the first plate 12 and the second plate 14, and showing the enclosure of the fluid flow channel 30. As shown therein and as described above, the sealing layer 16 is compressed against the first plate 12 and the ridge 32 surrounding the flow channels (e.g., flow channel 30) by the second plate 14. FIG. 14 illustrates valve actuation, whereby a plunger 124 of the linear actuator array is extendable linearly through the valve aperture 48 in the second plate 14 to compress the sealing layer 16 against the bottom of the valve recess 34 (or the ridge 54 of the valve recess 34) to close off the fluid flow channel 30 and prevent a flow of fluid past the valve recess 34.

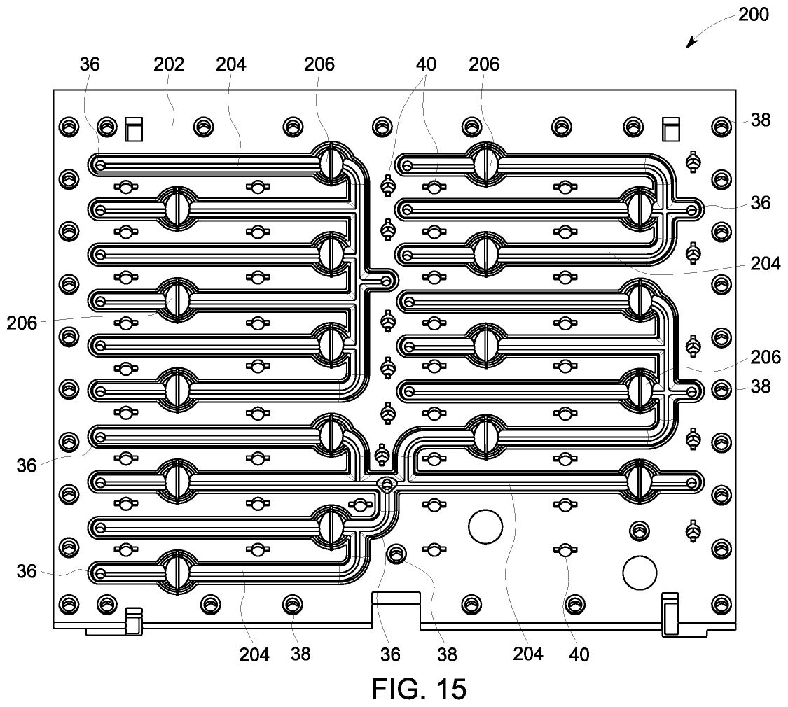

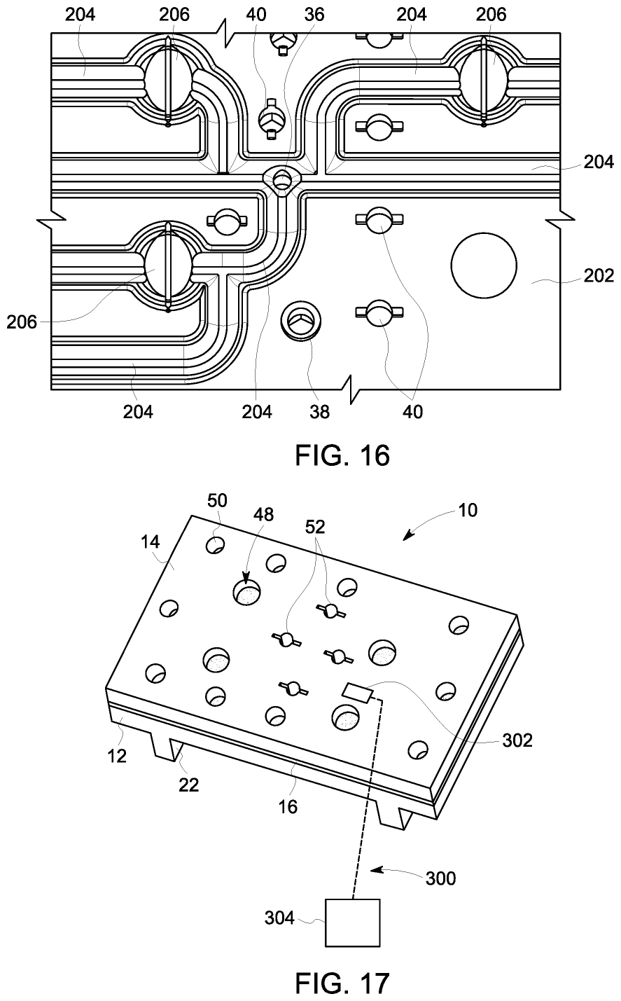

Turning now to FIG. 15, a fluid handling apparatus 200 according to another embodiment of the invention is illustrated. The construction and configuration of the fluid handling apparatus 200 is substantially similar to the construction and configuration of the fluid handling apparatus 10 described above, where like numerals designate like parts. The apparatus 200 includes a first plate 202 and sealing layer (not shown), and may include a second plate (not shown) having one or more features that mirror the features in the first plate (e.g., apertures, alignment protrusions, ridges, apertures for linear actuators, etc.), similar to those described above. In an embodiment, however, the second plate may be devoid of any features that mirror the features in the first plate. The fluid handling apparatus 200 includes a more specific arrangement of fluid flow channels 204, valve recesses 206, and number and location of alignment apertures/protrusions 38 and apertures 40 (and mirrored features on the unillustrated second plate). As illustrated in FIG. 15, apertures 40 that receive fasteners to compress the sealing layer between the plates are positioned intermediate each adjacent flow channel 204 and in close association with each flow channel 204. Moreover, as best shown in FIG. 16, the apertures 40 are of greater density (number of attachment points per unit area) at the intersections between the flow channels 204. As discussed above, while FIGS. 15 and 16 illustrate apertures for receiving mechanical fasteners, other attachment means such as heat staking may also be utilized without departing from the broader aspects of the invention. The greater density of attachment points adjacent to the turns and intersections between the flow channels ensures localized compression of the plates against the sealing layer, providing for a robust seal around the periphery of the flow channels.

While the fluid handling apparatuses are described herein as including a sealing layer 16 sandwiched and compressed between the first plate 12 and the second plate 14, in an embodiment, the second plate 12 may be omitted such that the apparatus only includes a first plate (e.g., first plate 10) with fluid flow channels (e.g., channels 24, 26, 28, 30) and a sealing layer attached to the first plate in such a manner so as to sealingly enclose the fluid flow channels 24, 26, 28, 30. Such a two-component apparatus eliminates one component (the second plate) and is operable in the same manner described above; namely, a linear actuator is extendable to compress the sealing layer against a valve recess or ridge of a valve recess along one of the fluid flow channels to occlude fluid flow. In an embodiment, the sealing layer, when used without the second plate, may be a silicone or thermoplastic polyurethane material. Other elastomeric materials may also be utilized without departing from the broader aspects of the invention. Rather than being compressed by a second plate against the first plate, however, the sealing layer may be affixed to the first plate using an adhesive, welding or similar joining methods.

While the invention has been described herein as including a first plate having a plurality of fluid flow channels and valve recesses for cooperating with an actuator and the sealing layer to occlude fluid flow through the channels and past the valve recesses, it is contemplated that the first plate may be generally flat and devoid of fluid control features. In particular, in an embodiment, one or more of the fluid flow channels, sealing ridges, valve ridges and/or other geometric features that allow for fluid flow, sealing and/or fluid occlusion can instead be incorporated into the sealing layer 16. Moreover, while the first and second plates 12, 14 and sealing layer 16 are illustrated as being substantially flat or planar in shape, in some embodiments, the plates and/or sealing layer may have bends or curves such that the plates and/or sealing layer have surfaces that lie in different planes. In yet additional embodiments, the apparatus of the invention may have more than one layer of fluid paths, such as, for example, a fluid flow channel on either side of the sealing layer (and formed in opposing sides of the sealing layer or in both the first and second plates). Similarly, in some embodiments, one or more of the fluid flow channels, sealing ridges, valve ridges and/or other geometric features that allow for fluid flow, sealing and/or fluid occlusion can instead be incorporated into a second plate 14, where present.

The fluid handling apparatus of the invention therefore provides a simple, reliable device for fluid handling in a bioprocessing system. In particular, the invention as shown and described herein enables cost-effective manufacturing of complex fluidic networks for single-use fluid management in biotherapeutic (e.g., cell therapies, monoclonal antibodies, etc.) as well as other fields where valve-controlled networks manage fluid flow. Such designs and processes may be used to manufacture devices for both liquid and gaseous fluid management.

The fluid handling apparatus 10 of the invention also helps to minimize the risk of fluid path leakage/contamination and the subsequent loss of product (e.g., a genetically modified therapeutic dose). The design of the fluid handling apparatus 10 reduces complexity, component count, assembly steps, and potential errors associated with the manufacture of single use cell therapy products to provide enhanced assurance that patients receive their intended therapeutic doses. In particular, decreasing part count and apparatus complexity decreases the risk of assembly errors, sub-assembly cost and system costs, as a whole. In addition, simplifying the apparatus as compared to existing fluid management systems decreases the potential for errors in plumbing the fluidic network and simplifies inspection and/or leak testing.

For certain operations, the ability to deliver fluid with relatively low retention volumes may be beneficial (e.g., antibodies and virus). Moreover, the apparatus of the invention allows the incorporation of different sized of fluidic paths in parallel, enabling lower volume dispensing of chosen reagents and other fluids.

With reference to FIG. 17, in an embodiment, for further feedback on the status of the fluid handling apparatus 10 and the fluid(s) within, a pressure transduction system 300 may be employed to monitor the internal pressure and pressure variations within the apparatus 10. Specifically, unsupported holes in the second plate 14, such as the valve apertures 48 are seen to move in response to internal pressure. Positive and negative displacements of the sealing layer 16 at these apertures 48 may be quantified by a position sensor 302 (e.g., optical, IR, mechanical, etc.) and correlated to internal pressure or pumping rate using a controller 304. This may act as a fail-safe to stop pump operation if there is an excessive internal pressure (i.e., all valves closed, etc.) or if the pump is operated in a dead-headed state (i.e., if a user has clamped off a line or if a line has become kinked) and allow for feedback to the user that the intended operation was not progressing correctly. The pressure/pump rate data may also be useful in verifying flow at specific parts of the fluidic manifold and act as a double-check that valving actions have been executed. In embodiments including a molded sealant layer, thinned apertures may be included to amplify the effects of pressure-related distention. Additionally, to more easily evaluate membrane displacement optically, filled silicone membranes with enhanced reflectivity may be applied locally.

In an embodiment, chemical or biological sensors may be applied to the fluid facing surfaces of the fluid handling apparatus to interrogate the liquid contents during transfer or perfusion operations. These sensors may be based on optical signals (e.g., fluorescence, color change, Raman intensity or turbidity) or radio frequency signals to interrogate the chemical and/or biological makeup of the fluid in the manifold at the time of measurement.

In connection with the embodiments described above, the fluid handling assemblies of the invention are configured for operation at a non-microfluidic scale, i.e., up to an exceeding about 200 mL/minute. In particular, the configuration of the fluid handling assemblies of the invention, including the material specifications for the plates and/or sealing layers and the flow area of the channels and valves, have been selected to handle the pressures and stresses generated by flow rates on the order of milliliters per minute (as contrasted with higher volume flow rates of liters (or greater) per minute, or with microfluidic flow rates of microliters per minute). In an embodiment, the cross-sectional areas of the channels and connected tubes ranges from about 2 square millimeters to about 35 square millimeters. This is in contrast to microfluid arrays which typically have channels with a cross-sectional area of less than about 0.5 square millimeters.

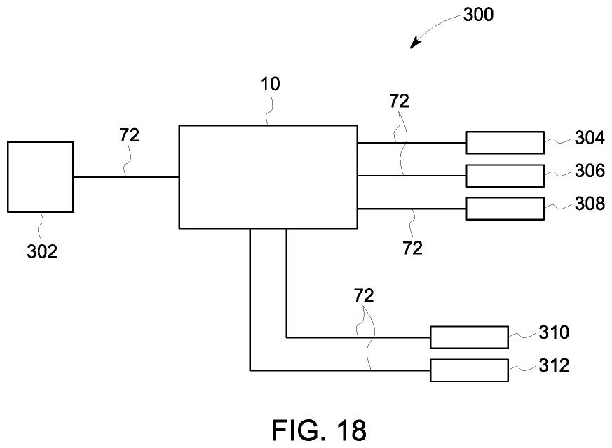

As mentioned above, and with reference to FIG. 18, the fluid handling apparatus 10 may be utilized to control the flow of fluids in a bioprocessing system. An exemplary bioprocessing system 300 includes, for example, a bioreactor vessel 302 configured for carrying out biochemical and/or biological processes (e.g., activation, genetic modification, and/or expansion of a population of cells), one or more bioprocessing devices (e.g., bioprocessing device(s) 304, 306, 308, 310, 312), and fluid handling assembly according to one of the embodiments described herein (e.g., fluid handling assembly 10 of FIG. 1). The fluid handling assembly 10 is configured for fluid connection to the bioreactor vessel 302 and to the various bioprocessing devices 302-312, such as through tubes 72. As described above, the fluid handling apparatus 10 is positioned so as to be acted upon by a plurality of actuators for selectively allowing or preventing a flow of fluid through one or more of the fluid flow channels of the fluid handling assembly, in the manner described above. It is contemplated that the bioprocessing devices 302-312 may be any an apparatus, device, kit, or assembly, suitable for processing biomaterials, e.g., expanding, concentrating and/or washing cells. Such devices include, but are not limited to, bioreactors, bioreactor vessels, centrifuges, wash kits, filters and the like. Moreover, it is contemplated that one or more of the bioprocessing device(s) may be flexible bags or reservoirs containing various fluids for use in a bioprocessing operation, including, but not limited to, media, rinse buffer, cells, antibody solutions, inoculum. In addition, one or more of the bioprocessing devices may be a collection bag or reservoir (such as for the collection of biological waste products and/or an expanded population of target cells). As illustrated in FIG. 18, therefore, the fluid handling apparatus 10, in concert with an actuator assembly, provides for the precise control of fluid flow to, from and between the various system components connected to the fluid handling apparatus 10.

In an embodiment, a fluid handling apparatus for a bioprocessing system includes a first plate having a first surface and a second surface and a sealing layer disposed over the first surface. At least one fluid flow channel is formed in one of the first surface of the first plate or the sealing layer. At least one valve recess is formed in one of the first surface of the first plate or the sealing layer. The least one valve recess is configured to cooperate with an actuator to prevent a flow of fluid through the at least one fluid flow channel. In an embodiment, the at least one fluid flow channel is in the first surface of the first plate, the at least one valve recess is in the first surface along the at least one fluid flow channel, and the at least one fluid passageway extends through the first plate from the at least one fluid flow channel to the second surface, and the sealing layer encloses the at least one fluid flow channel. In an embodiment, the first plate includes a ridge protruding above the first surface along substantially an entire periphery of the at least one fluid flow channel, the ridge being configured to contact the sealing layer to form a seal. In an embodiment, the ridge has an inverted v-shaped or rounded profile. In an embodiment, the ridge is a plurality of spaced-apart ridges configured to contact the sealing layer to form a plurality of seals. In an embodiment, the valve recess includes a valve ridge extending across the valve recess perpendicular to a direction of fluid flow, the valve ridge being configured to cooperate with the sealing layer to prevent a flow of fluid past the valve recess. In an embodiment, the first plate comprises a rigid material, and the sealing layer comprises a flexible material. In an embodiment, the sealing layer may comprise a cross-linked, hydrophobic material. In an embodiment, the at least one fluid flow channel is a plurality of fluid flow channels, wherein at least one of the plurality of fluid flow channels intersects with at least another of the plurality of fluid flow channels. In an embodiment, the apparatus may further include a second plate sandwiching the sealing layer against the first plate. The second plate may include at least one aperture in alignment with the at least one valve recess such that the actuator is extendable through the at least one aperture in the second plate to bias the sealing layer into contact with a surface of the at least one valve recesses to occlude fluid flow through the at least one fluid flow channel. The second plate is mechanically joined to the first plate and compressed against the first plate. In an embodiment, one of the first plate and the second plate includes a plurality of alignment projections, and the other of the first plate and the second plate includes a plurality of alignment recesses or apertures configured to receive the alignment projections.

In another embodiment, a fluid control system includes an array of actuators and a fluidic manifold. The fluidic manifold includes a first plate having a first surface and a second surface, a plurality of fluidic channels formed in the first surface, a plurality of valve recesses formed in the first surface along one or more of the fluidic channels, and at least one fluid passageway extending through the first plate from at least one of the fluidic channels to the second surface, and a sealing layer disposed over the first surface and enclosing the plurality of fluidic channels. Each of the actuators is moveable into engagement with the sealing layer of the fluidic manifold to urge the sealing layer into contact with a surface of a corresponding valve recess to occlude fluid flow in at least one of the fluidic channels. In an embodiment, each of the fluidic channels is bounded by a ridge that protrudes above the first surface of the fluidic plate, the ridges of each fluidic channel being configured to contact the sealing layer to form a seal. In an embodiment, the ridge has a v-shaped or rounded profile. In an embodiment, the first plate is substantially rigid and the sealing layer comprises an elastomeric or resilient material. In an embodiment, the sealing layer comprises a cross-linked, hydrophobic material. In an embodiment, the fluidic manifold further includes a second plate, the sealing layer being disposed between the first plate and the second plate, the second plate having a plurality of apertures in alignment with the plurality of valve recesses. The actuators are extendable through the apertures in the second plate to urge the sealing layer into contact with a surface of the corresponding valve recesses to occlude fluid flow through one or more of the fluidic channels.

In yet another embodiment, a method of fluid control for a bioprocessing system includes the steps of arranging a fluidic manifold adjacent to an array of actuators, the fluidic manifold including a first plate having a first surface and a second surface, at least one fluid flow channel formed in the first surface, at least one valve recesses formed in the first surface along a fluidic channel of the at least one fluidic channel, and a sealing layer disposed over the first surface and enclosing the at least one fluid flow channel, and actuating at least one of the actuators to urge the sealing layer into contact with a valve recess to occlude fluid flow past the valve recess. In an embodiment, the method also includes the step of connecting a fluid flow line to the fluidic manifold such that the fluid flow line is in fluid communication with the at least one fluid flow channel.

In yet another embodiment, a fluid handling apparatus for a bioprocessing system includes a first plate having a first surface and a second surface, a sealing layer in registration with the first surface, at least one fluid flow channel formed in at least one of the first surface and the sealing layer, at least one valve recess formed in at least one of the first surface and the sealing layer along the at least one fluid flow channel, and at least one fluid passageway extending through the first plate from the at least one fluid flow channel to the second surface. The at least one valve recess is configured to cooperate with an actuator and the sealing layer to prevent a flow of fluid through the at least one fluid flow channel.

In yet another embodiment, a bioprocessing system includes a bioreactor vessel, a bioprocessing device, and a fluid handling apparatus configured for fluid connection to the bioreactor vessel and the bioprocessing device, the fluid handling apparatus including a first plate and a sealing layer, at least one fluid flow channel in the first plate or the sealing layer, and at least one valve recess in the first plate or the sealing layer. The at least one valve recess is configured to cooperate with an actuator to prevent a flow of fluid through the at least one fluid flow channel.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A fluid handling apparatus for a bioprocessing system, comprising:
a first plate having a first surface and a second surface; and
a sealing layer disposed over the first surface;
wherein at least one fluid flow channel is formed in one of the first surface of the first plate or the sealing layer;
wherein at least one valve recess is formed in one of the first surface of the first plate or the sealing layer; and
wherein the at least one valve recess is configured to cooperate with an actuator to prevent a flow of fluid through the at least one fluid flow channel.

2. The fluid handling apparatus of claim 1, wherein:
the at least one fluid flow channel is in the first surface of the first plate, the at least one valve recess is in the first surface along the at least one fluid flow channel, and the at least one fluid passageway extends through the first plate from the at least one fluid flow channel to the second surface; and
wherein the sealing layer encloses the at least one fluid flow channel.

3. The fluid handling apparatus of claim 2, wherein:
the first plate includes a ridge protruding above the first surface along substantially an entire periphery of the at least one fluid flow channel, the ridge being configured to contact the sealing layer to form a seal.

4. The fluid handling apparatus of claim 3, wherein:
the ridge has an inverted v-shape or rounded profile.

5. The fluid handling apparatus of claim 2, wherein:
the ridge is a plurality of spaced-apart ridges configured to contact the sealing layer to form a plurality of seals.

6. The fluid handling apparatus of claim 2, wherein:
the valve recess includes a valve ridge extending across the valve recess perpendicular to a direction of fluid flow, the valve ridge being configured to cooperate with the sealing layer to prevent a flow of fluid past the valve recess.

7. The fluid handling apparatus of claim 2, wherein:
the first plate comprises a rigid; material and
the sealing layer comprises a flexible material.

8. The fluid handling apparatus of claim 2, wherein:
the at least one fluid flow channel is a plurality of fluid flow channels;
wherein at least one of the plurality of fluid flow channels intersects with at least another of the plurality of fluid flow channels.

9. The fluid handling apparatus of claim 2, further comprising:
a second plate sandwiching the sealing layer against the first plate.

10. The fluid handling apparatus of claim 9, wherein:
the second plate includes at least one aperture in alignment with the at least one valve recess such that the actuator is extendable through the at least one aperture in the second plate to bias the sealing layer into contact with a surface of the at least one valve recesses to occlude fluid flow through the at least one fluid flow channel.

11. The fluid handling apparatus of claim 10, wherein:
the second plate is mechanically joined to the first plate and compressed against the first plate.

12. A fluid control system, comprising:
a plurality of actuators; and
a fluidic manifold including:
a first plate having a first surface and a second surface, a plurality of fluidic channels formed in the first surface, a plurality of valve recesses formed in the first surface along one or more of the fluidic channels, and at least one fluid passageway extending through the first plate from at least one of the fluidic channels to the second surface; and
a sealing layer disposed over the first surface and enclosing the plurality of fluidic channels;
wherein each of the actuators is moveable into engagement with the sealing layer of the fluidic manifold to urge the sealing layer into contact with a surface of a corresponding valve recess to occlude fluid flow in at least one of the fluidic channels.

13. The fluid control system of claim 12, wherein:
each of the fluidic channels is bounded by a ridge that protrudes above the first surface of the fluidic plate, the ridges of each fluidic channel being configured to contact the sealing layer to form a seal.

14. The fluid control system of claim 13, wherein:
the ridge has an inverted v-shaped or rounded profile.

15. The fluid control system of claim 12, wherein:
the first plate comprises a rigid; material and
the sealing layer comprises a flexible material.

16. The fluid control system of claim 12, wherein:
the fluidic manifold further includes a second plate, the sealing layer being disposed intermediate the first plate and the second plate, the second plate having a plurality of apertures in alignment with the plurality of valve recesses;
wherein the actuators are extendable through the apertures in the second plate to urge the sealing layer into contact with a surface of the corresponding valve recesses to occlude fluid flow through one or more of the fluidic channels.

17. A method of fluid control for a bioprocessing system, comprising the steps of:
arranging a fluidic manifold adjacent to an plurality of actuators, the fluidic manifold including a first plate having a first surface and a second surface, at least one fluid flow channel formed in the first surface, at least one valve recesses formed in the first surface along the at least one fluid flow channel, and a sealing layer disposed over the first surface and enclosing the at least one fluid flow channel; and
actuating at least one of the actuators to urge the sealing layer into contact with a valve recess to occlude fluid flow past the valve recess.

18. The method according to claim 17, further comprising the step of:
connecting a fluid flow line to the fluidic manifold such that the fluid flow line is in fluid communication with the at least one fluid flow channel.

19. A fluid handling apparatus for a bioprocessing system, comprising:
a first plate having a first surface and a second surface;
a sealing layer in registration with the first surface;
at least one fluid flow channel formed in at least one of the first surface and the sealing layer;
at least one valve recess formed in at least one of the first surface and the sealing layer along the at least one fluid flow channel;
and at least one fluid passageway extending through the first plate from the at least one fluid flow channel to the second surface;
wherein the at least one valve recess is configured to cooperate with an actuator and the sealing layer to prevent a flow of fluid through the at least one fluid flow channel.

20. A bioprocessing system, comprising:
a bioreactor vessel;
a bioprocessing device; and
a fluid handling apparatus configured for fluid connection to the bioreactor vessel and the bioprocessing device, the fluid handling apparatus including a first plate and a sealing layer, at least one fluid flow channel in the first plate or the sealing layer, and at least one valve recess in the first plate or the sealing layer;
wherein the at least one valve recess is configured to cooperate with an actuator to prevent a flow of fluid through the at least one fluid flow channel.

21. The bioprocessing system of claim 21, wherein:
the at least one fluid flow channel is in the first surface of the first plate, the at least one valve recess is in the first surface along the at least one fluid flow channel, and the at least one fluid passageway extends through the first plate from the at least one fluid flow channel to the second surface; and
wherein the sealing layer encloses the at least one fluid flow channel.

22. The bioprocessing system of claim 20, wherein:
the first plate comprises a rigid; material and
the sealing layer comprises a flexible material.
